(19) United States
(12) Patent Application Publication
(10) Pub. No.: US 2011/0038657 A1
(43) Pub. Date: Feb. 17, 2011

(54) Print System

(76) Inventor: Moshe Benizri, Kefar Sava (IL)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/541,960

(22) Filed: Aug. 16, 2009

(51) Int. Cl. B41J 15/00

(52) U.S. Cl. 400/618

(57) ABSTRACT

Print substrate roll axle, comprising a support portion arranged to support a substrate roll near one end, a transmission member arranged to connect to a substrate roll drive mechanism, and a resilient member for engaging the substrate roll, wherein at least a part of the resilient member is arranged to move in a circumferential direction with respect to the axle for transmitting a torque to the substrate roll.

### BACKGROUND OF THE INVENTION

In large format printing usually large size print systems are used to print on large size substrates. The substrates are usually provided in rolled form. The substrates may comprise flexible substrates such as paper, vinyl or the like. The substrates are wound around a hollow shaft. Such rolled substrates are sometimes called substrate rolls or media rolls.

Before printing the substrate, a bar assembly may be coupled to the hollow shaft of the substrate roll so as to allow mounting of the substrate roll onto the printer, and subsequent rotation, unwinding and winding of the substrate roll in the printer. The bar assembly may consist of, amongst others, a shaft, a toothed gear wheel, locking units, two cones at each end, and a number of bushings, rings, bearings, screws, nuts, etc.

Before mounting the substrate roll on the printer, the bar assembly needs to be assembled. First, the bar is slid through the hollow core of the substrate roll. On each end of the bar, the cones are slid over the bar so that the substrate roll is clamped between the tapered ends of the cones. The cones are fixedly connected to the bar by way of screws. In this way, the substrate roll is fixed to the bar. On one end, the toothed gear wheel is fixed to the bar by way of locking units, a retaining ring, screws and other fixing means. Also at least one bearing is mounted onto the bar so as to facilitate rotation of the bar assembly in the printer. Before the substrate roll can be taken off, the bar assembly has to be disassembled again. The bar assembly has many separate parts that need to be assembled. Assembly and disassembly of the bar assembly as well as mounting and dismounting the substrate roll takes a lot of time. Because of the complexity of the bar assembly, an operator needs to have pre-knowledge and/or experience to assemble the bar assembly and mount the substrate roll. Moreover, loss of one of the parts may easily occur.

Once mounted, rotation of the substrate roll is controlled by a driving mechanism. The driving mechanism is arranged to wind and unwind the substrate roll while maintaining a tension in the substrate. To maintain a tension in the substrate while rotating the substrate roll, a gear mechanism and a tension control system are provided. The tension control system may monitor the tension of the substrate and signal the driving mechanism to maintain sufficient tension. Depending on characteristics of the substrate such as thickness and material, the motor has to provide for, and withstand, varying torques to enable a sufficient tension in the substrate. In large format printing torques can be high.

Some systems are not capable of adequately controlling the rotation and tension of the substrate under varying loads and torques. It requires relatively costly and sophisticated driving mechanisms to be able to handle different substrate rolls of different lengths, widths, thicknesses and materials. If the tension in the substrate is not maintained at a desired level, this may affect the printed image quality.

It is therefore one of the objects of the invention to alleviate at least one of above explained disadvantages.

### BRIEF DESCRIPTION OF THE DRAWINGS

For the purpose of illustration, certain embodiments of the present invention will now be described with reference to the accompanying diagrammatic drawings, in which:

FIG. 1A schematically shows a front view of a print system;

FIG. 1B schematically shows a cross sectional side view of several parts of the print system of 1A;

FIG. 2 schematically shows a perspective, partially transparent view of two print substrate roll axles and a substrate roll support portion;

FIG. 3 schematically shows one of the substrate roll axles of FIG. 2 in perspective view;

FIG. 4 schematically shows another one of the substrate roll axles of FIG. 2 in perspective view;

FIG. 5 schematically shows a cross-sectional side view of the substrate roll axle of FIG. 3, near the distal end 15 thereof;

FIG. 6 schematically shows a cross-sectional side view of the substrate roll axle of FIG. 3, near the distal end 15 thereof, as in FIG. 5, wherein the distal end of the resilient member and the hollow core of the substrate roll are rotated with respect to the axle.

### DETAILED DESCRIPTION

In the following detailed description, reference is made to the accompanying drawings. The embodiments in the description and drawings should be considered illustrative and are not to be considered as limiting to the specific embodiment of element described. Multiple embodiments may be derived from the following description through modification, combination or variation of certain elements. Furthermore, it may be understood that also embodiments or elements that may not be specifically disclosed may be derived from the description and drawings.

In this description, a substrate roll may comprise a wound substrate. The substrate roll may have a hollow core to allow the substrate to be mounted on a spindle or axle. The hollow core may be formed by the inner surface of the substrate itself or may comprise a shaft around which a substrate is wound. The substrate roll may be a known substrate roll.

When rotating the substrate roll in a print system, a part of the substrate may be unwound. In such condition, the substrate roll comprises a wound part, and an unwound part. The wound part may comprise multiple layers of substrate wound around the hollow core. The wound part may be essentially cylindrical. The unwound part may comprise a layer of unwound substrate. For example, the unwound part may span the space between the substrate roll and receiving roll that may respectively unwind and wind. The unwound part may extend along the print head or a printer drying mechanism or the like.

The substrate may comprise printable material such as paper, film, foil, textile, fabric, canvas or any other type of printable substrate. The substrate may be flexible so as to allow winding of the substrate. Sufficient tension in the unwound part of the substrate may be advantageous so as to avoid wrinkling, folding, misalignment, or other influences that may negatively affect the print quality.

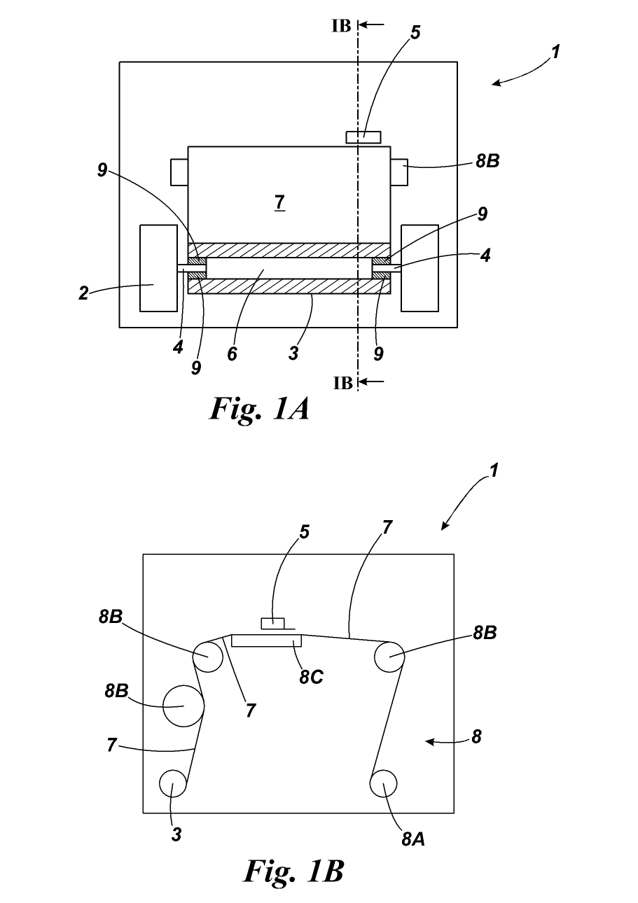

FIGS. 1A and 1B schematically show a diagrammatic overview of an exemplary print system 1. FIG. 1B is a diagrammatic cross sectional side view of FIG. 1A. The print system 1 may comprise a drive mechanism 2. A substrate roll 3 may be coupled to the drive mechanism 2. Two axles 4 may be provided for mounting the substrate roll 3. The print system 1 may comprise any type of print system 1, for example, but not limited to, a digital press, a laser and/or ink jet printer. The print system 1 may comprise a large format printer. The print system 1 may be arranged to process and print substrate rolls 3 of widths of between approximately 0.8 and 5 meter, for example between approximately 1.2 and 3.2 meter.

The drive mechanism 2 may comprise a motor, a gear mechanism and a tension control circuit. The drive mechanism 2 may be arranged to control a rotation of the substrate roll 3 so that the substrate roll 3 may be wound and/or unwound. The drive mechanism 2 may be arranged to deliver a torque of the axles 4. The drive mechanism 2 may be arranged to monitor and maintain a tension in the substrate. The axle 4 may transmit the torque of the drive mechanism 2 to the substrate roll 3. One axle 4 may extend on each end of the substrate roll 3.

The print system 1 may further comprise a print head 5. The print head 5 may be arranged to dispense a colorizing substance to the substrate in a controlled manner. The colorizing substance may comprise, but is not limited to, fluids, suspensions and dissolutions, optionally comprising particles, which may include a pigment, dye, ink, oil, latex, or wax based inks, or the like. This disclosure may in principle relate to any printing technique involving web substrates printing.

The substrate roll 3 may comprise a substrate that is wound multiple times around a hollow core 6. A further part 7 of the substrate may be unwound from the substrate roll 3, extending between the substrate roll 3 and the print head 4, as schematically illustrated by FIG. 1A. The unwound part 7 may be tensioned to prevent formation of undulations in the substrate. A substrate receiving engagement assembly 8 may be provided to aid in providing a tension in the unwound substrate part 7, and to align the substrate. The unwound part 7 may be tensioned between the substrate roll 3 and the receiving engagement assembly 8 (FIG. 1A). The drive mechanism 2 and the receiving engagement assembly 8 may be arranged to provide and/or maintain the tension in the unwound part 7. For example, the receiving engagement assembly 8 may comprise one or more receiving rolls 8A, such as cylindrical rolls or hollow cores for guiding, winding and/or unwinding the substrate. Also further guiding rolls and tensions rolls 8B may be provided to aid in guiding and tensioning the substrate and/or guiding elements 8C may be provided for supporting and/or guiding the substrate with respect to the print head 5.

The receiving rolls 8A may be similar to the substrate rolls 3, wherein the substrate roll 3 may be unwound and the receiving roll 8A is wound, while maintaining a tension. The receiving roll 8A may be provided with a hollow core, similar to the hollow core 6 of the substrate roll 3. The receiving engagement assembly 8 may comprise a driving mechanism. The receiving roll 8A may be mounted onto the axles 4, in the same manner as the substrate roll 3, wherein a torque may be transmitted from the driving assembly to the receiving roll 8A via the axle 4.

The receiving engagement assembly 8 may be arranged to allow a relatively tight and flat substrate to move along the print head 5 at a relatively small distance from the print head 5, for example 5 millimeter or less, for example approximately 1 millimeter. If a certain flatness of the substrate is not achieved at such small distances, image quality may deteriorate.

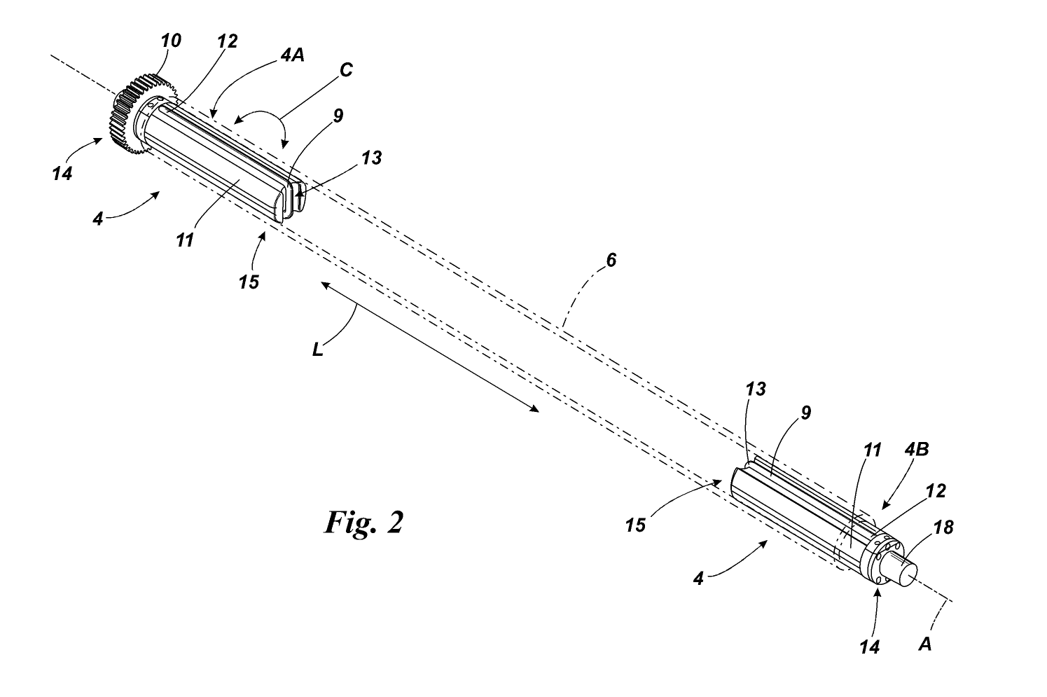

The axle 4 may comprise a resilient member 9, also shown in FIG. 2-6. The resilient member 9 may be arranged to engage an inner wall of the hollow core 6, of the substrate roll 3. The diameter of the resilient member 9 and the axle 4 may together be approximately equal to the inner diameter of the hollow core 6, so as to engage the hollow core 6 while allowing to be moved inside the hollow core 6. The resilient member 9 and the axle 4 may be arranged so that there may be enough friction between the resilient member 9 and the hollow core 6 to hold the substrate roll 3 in place, at least in a longitudinal direction, while allowing the axle 4 to be moved in and out of the hollow core 6 using manual force. The resilient member 9 may extend on at least two opposite sides of the axle 4.

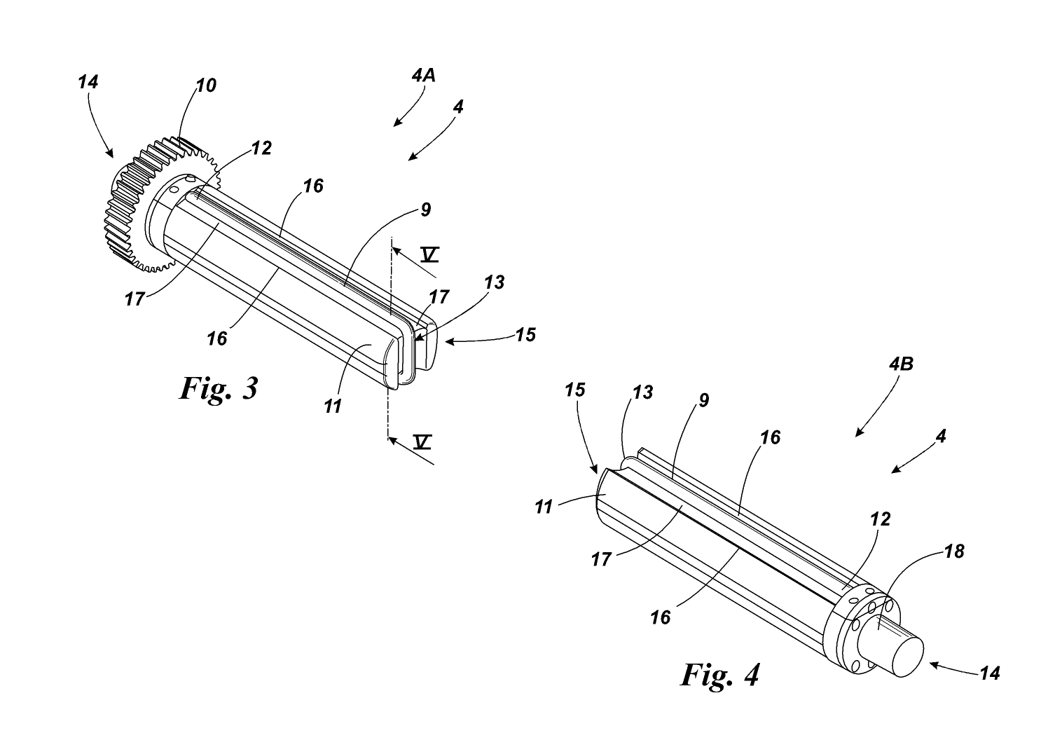

FIG. 2 shows an assembly of two opposite axles 4 and a hollow core 6 that is mounted on the two axles 4. The two axles 4 may comprise a drive axle 4A and a second axle 4B, separately shown in FIGS. 3 and 4, respectively. For illustration purposes, the hollow core 6 is indicated in dashed lines in the form of a hollow shaft, and the substrate is not shown.

At least one of the axles 4 may comprise a transmission member 10. The drive axle 4A may comprise the transmission member 10 (FIG. 3). The transmission member 10 may comprise a gear, for example a toothed gear. The axles 4 and the substrate roll 3 may rotate about an axis of rotation A. The transmission member 10 may be arranged to engage the respective drive mechanism 2 so as to be rotated by the drive mechanism 2 and rotate the axle 4 about the axis of rotation A. The transmission member 10 may be arranged to transmit the torque, e.g. a drive or brake action of the motor, to the respective axle 4 and the substrate roll 3. The transmission member 10 may connect to a corresponding gear of the drive mechanism 2.

The axle 4 may comprise a support portion 11. The support portion 11 may be arranged to fit inside the hollow shaft 6 of the substrate roll 3, whereas the transmission member 10 may be arranged to extend outside of the substrate roll 3 SO as to engage the drive mechanism 2. The support portion 11 may comprise a bar or shaft like shape.

The resilient member 9 may comprise elastomeric material such as rubber or an elastomeric polymer. The resilient member 9 may have a substantially elongate shape. The resilient member 9 may stretch and/or bend with respect to the axle 4. The resilient member 9 may be pre-stretched along its length and spanned along the support portion 11.

As can be seen from FIG. 2, in a non-stretched and non-bended condition, the resilient member 9 may extend at least partially parallel to the axle 4 and/or to the axis of rotation A, and/or in a longitudinal direction of the axle 4 and the substrate roll 4. The resilient member 9 may extend along the support portion 11. The resilient member 9 may abut the support portion 11 along a substantial part of the length of the resilient member 9. The substrate roll 3 may be supported by the support portion 11 on the resilient member 9.

The resilient member 9 may have a proximal end 12 and a distal end 13. The proximal end 12 may be fixed to the axle 4 at fixation locations 12A. The resilient element 9 may be fixed to a flange or gear of the respective axle 4. The proximal end 12 may be attached to the proximal end 14 of the axle 4. The distal end 13 may be arranged so as to move with respect to the axle 4, at least for a certain distance. The distal end 13 of the resilient member 9 may extend near the distal end 15 of the axle 4. The proximal end 12 may be fixed to the axle 4, while the remaining part of the resilient member 9 may be moved along the axle 4 in so far as this may be allowed by the resiliency of the member 9. As shown in FIG. 2, the resilient member 9 may comprise two proximal ends 12 that may be fixedly attached to the axle 4.

The resilient member 9 may extend along two opposite sides of the axle 4, from the proximal end 14 of the axle 4 along the support portion 11 to the distal end 15 of the support portion 11. The resilient member 9 may extend along the distal end 15 of the axle 11, approximately perpendicular to the axis of rotation A. The resilient member 9 may comprise a U-shape, the legs of the U extending along the length of the support portion 11, parallel to the axis of rotation A, the bridging part of the U-shape extending along the distal end 15 of the support portion 11, perpendicular to the axis of rotation A.

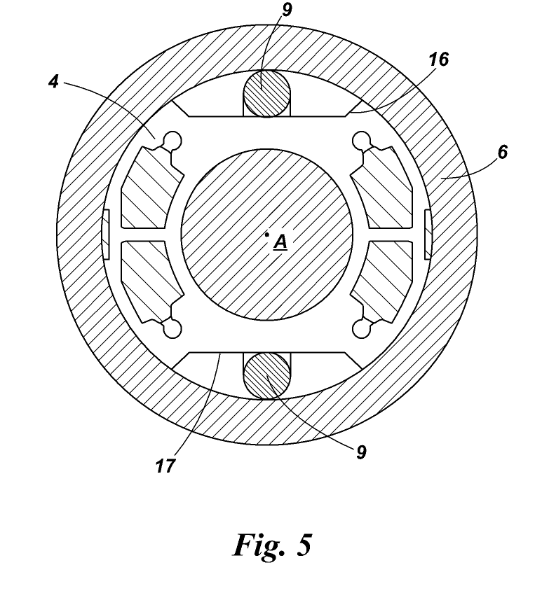

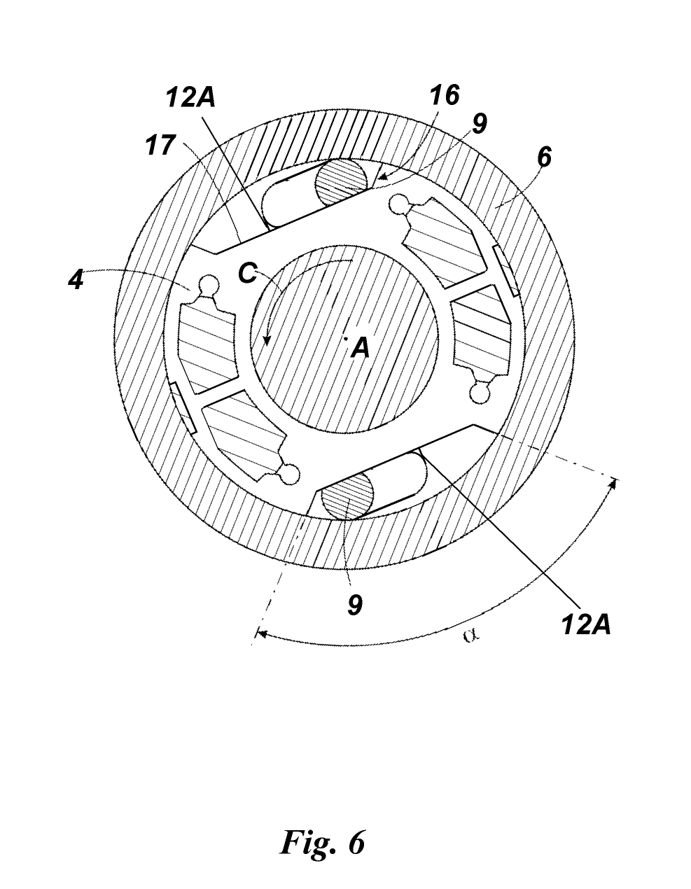

Two exemplary conditions of the resilient member 9 are illustrated in FIGS. 5 and 6. An axle 4 having mounted a substrate roll 3 is shown. For illustrative purposes, only the hollow core 6 of the substrate roll 3 is shown and the substrate itself is not shown in the drawing. FIG. 5 may illustrate a condition wherein there is no or little tension in the unwound substrate part 7 so that the opposite cords of the resilient member 9 may extend substantially parallel.

When the axle 4 rotates in a direction of rotation C, the unwound part 7 may be tensioned, which may trigger a counter torque movement of the resilient member 9 as shown in FIG. 6 due to friction between the resilient member 9 and the substrate roll 3. The resilient member 9 may compensate for a part of the torque onto the drive mechanism 2.

At least a part of the resilient member 9 may be arranged to move in a circumferential direction C of the axle 4, with respect to the axle 4. In use, this may in turn allow the axle 4 to move with respect to a part of the resilient member 9 and the substrate roll 3, as will be explained below. The resilient member 9 may be arranged to at least partly move with respect to the circumferential surface of the axle 4 by bending and stretching. In FIG. 6 resilient member 9 is shown to have moved with respect to the axle 4. The axle 4 may have rotated in a direction C while the distal end 13 of the resilient member 9 remained in place, or rotated more slowly, due to friction between the resilient member 9 and the substrate roll 3. However the proximal ends 12 may move with the axle 4 because those are fixed to the axle 4 at fixation locations 12A

In a first stage of rotation of the axle 4, the axle 4 may move in the direction C with respect to the distal end 13 of the resilient member 9. The distal end 13 of the resilient member 9 may bend and stretch with respect to the proximal ends 12 of the resilient member 9. The distal end 13 may be at least partly retained by the friction force exerted by the inside of the hollow core 6 of the substrate roll 3. At the first stage of rotation of the axle 4, the substrate roll 3 may remain static, or rotate slower than the axle 4, in other words the axle 4 may rotate with respect to the substrate roll 3 in the circumferential direction C. At this first stage, the friction force of the resilient member 9 onto the substrate roll 3 may be enough so that the resilient member 9 is partly retained by the substrate roll 3, but not strong enough to engage the substrate roll 3 to rotate together with the axle 4. This may have an advantageous effect onto the stretching of the substrate during the startup process of rotation, for example preventing relatively sudden, high increases of stress in the substrate, or sudden, high increases in torque in the drive mechanism 2.

The axle 4 may comprise at least one abutment edge 16 that is arranged to stop the respective moving part of the resilient member 9, so that further movement of the resilient member 9 with respect to the axle 4 may be prevented. The axle 4 may comprise two abutment edges 16, so that on resilient member 9 may be prevented from further movement with respect to the axle 4 in two directions. For example, the resilient member 9 may have two extreme, stretched, conditions (e.g. FIG. 6), abutting one of the abutment edges 16. The extreme positions of the resilient member 9 may be determined by the abutment edges 16.

The axle 4 may comprise at least one cut out 17. The resilient member 9 may extend in the cut out 17, between the abutment edges 16. The cut out 17 may extend in a longitudinal direction, approximately along the length of the support portion 11. The cut out 17 may comprise an elongate cut out. The edges of the cut out 17 may be formed by the abutment edges 16.

The arrangement of the abutment edges 16 may determine the maximum angular movement of the resilient member 9 and the substrate roll 3 with respect to the axle 4 during the first stage. The distance that the substrate roll 3 is allowed to move with respect to the axle 4 may be determined by the distance between a start position of the resilient member 9 when it is not subject to a torque (FIG. 5), and the abutment edge 16. The axle 4 may rotate with respect to the substrate roll 3 within a certain angular range a determined by the abutment edges 16. For example, the angular range a may be between 10 and 90 degrees, for example between 20 and 60 degrees.

When the resilient member 9 abuts the abutment edge 16 due to sufficient rotation of the axle 4, the resilient member 9 may reduce width in a circumferential direction C, by the pressing force of the abutment edge 16. Due to its resiliency, the resilient member 9 may expand in a direction perpendicular to the rotational direction A so as to relatively strongly engage the substrate roll 3. The substrate roll 3 may then be rotated together with the axle 4 by the relatively strong engagement of the resilient member 9.

In other embodiments, the abutment edges 16 may comprise protrusions, ridges, upstanding walls or the like, or other means for limiting a movement of the resilient member 9. The resilient member 9 may be arranged to move in a clockwise direction of the axle 4, and/or in a counter clockwise direction of the axle 4, wherein the angular movement restrictions may be determined by the abutment edges 16.

The drive mechanism 2 may rotate the substrate roll 3 to wind and/or unwind the substrate. As explained above, the unwound part 7 may extend between the substrate roll 3 and the respective receiving engagement assembly 8. At certain moments, for example as a result of sudden changes in tension of the unwound part 7, relatively large changes in torque may occur, for example, when starting a winding or unwinding process. In such cases, the resilient member 9 may compensate for the corresponding increase in torque and/or prevent it from being directly and/or fully transmitted to the drive mechanism 2. This may prevent damage of the substrate and/or printed image. This may for example be advantageous for large format printers for printing relatively heavy substrate rolls 3. Here, the print systems 1 may have to work with relatively large torques, so that use of the resilient members 9 may be advantageous.

The second axle 4B may be provided with a similar resilient member 9, having similar features as explained above. The second axle 4B may comprise a rotation portion 18 for supporting the axle 4 in an axle support. Rotation of the drive axle 4A may trigger rotation of the substrate roll 3, whereas the rotation of the substrate roll 3 may trigger a rotation of the second axle 4B. The resilient member 9 may move for a certain distance with the substrate roll 3 when the substrate roll 3 starts rotating, before the whole axle 4 may start rotating.

The axle 4 and the resilient member 9 may allow for a relatively user friendly system for mounting the substrate roll 3 onto a print system 1. The axle 4 may be inserted into the substrate roll 3 relatively easily. The axle 4 may allow for relatively small and few parts, and easy operation. The arrangement of the axle 4 may be relatively cost efficient with respect to existing bar assemblies. Moreover, the axle 4 may limit the use of separate tools and parts.

In certain embodiments, only one axle 4 may be provided. For example one axle 4 may extend through the whole of the substrate roll 3 for supporting the substrate roll 3. Such one axle 4 may be provided with one or more resilient members 9. In certain embodiments, two or more resilient members 9 may be provided per axle 4. In other embodiments, two axles 4 may be provided, of which only one axle 4, for example the drive axle 4A, may be provided with the resilient element 9. Multiple combinations and/or variations are possible.

The axles 4 may be advantageous for both winding and unwinding mechanisms, and/or for both supply and collection of the substrate. The axles 4 may be advantageous for mounting and rotating rolls that undergo a torque. For example, the axles 4 may be mounted in complementary winding and unwinding mechanisms. The axle 4 may be arranged to rotate and/or mount either or both of a substrate roll 3 and a receiving roll 8A. The axle 4 may also be applied in guiding and/or tensioning rolls 8B.

In a first aspect, a print substrate roll axle 4 may be provided, which may comprise a support portion 11 arranged to support a substrate roll 3 near at least one end, a transmission member 10 arranged to connect to a substrate roll drive mechanism 2, and a resilient member 9 for engaging the substrate roll 3, wherein at least a part of the resilient member 9 is arranged to move in a circumferential direction C with respect to the axle 4 for transmitting a torque to the substrate roll 3.

In a second aspect, a print system 1 may be provided, which may comprise a substrate roll 3, a drive mechanism 2 coupled the substrate roll 3 for controlling a rotation of the substrate roll 3, and a resilient member 9 arranged between the substrate roll 3 and the drive mechanism 2, arranged to at least partly move in a rotational direction C of the substrate roll 3.

In a third aspect, a method of maintaining a tension in a substrate for printing may be provided, comprising connecting a substrate roll 3 to a print system 1, the print system 1 engaging the substrate roll 3 via a resilient member 9, moving an unwound part 7 of the substrate roll 3 between the substrate roll 3 and a print head 5 of the print system 1, and stretching the resilient member 9 so that a torque is provided to the substrate roll 3 by the resilient member 9.

The above description is not intended to be exhaustive or to limit the invention to the embodiments disclosed. Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality, while a reference to a certain number of elements does not exclude the possibility having more elements. A single unit may fulfill the functions of several items recited in the disclosure, and vice versa several items may fulfill the function of one unit.

The mere fact that certain measures are recited in mutually different dependent claims does not indicate that a combination of these measured cannot be used to advantage. Multiple alternatives, equivalents, variations and combinations may be made without departing from the scope of the invention.

1. Print substrate roll axle, comprising
a support portion arranged to support a substrate roll near at least one end,
a transmission member arranged to connect to a substrate roll drive mechanism, and
a resilient member for engaging the substrate roll, wherein at least a part of the resilient member is arranged to move in a circumferential direction with respect to the axle for transmitting a torque to the substrate roll.

2. Print substrate roll axle according to claim 1, wherein the resilient member comprises elastomeric material.

3. Print substrate roll axle according to claim 1, wherein the resilient member has a substantially elongate shape, extending approximately parallel to an axis of rotation of the axle.

4. Print substrate roll axle according to claim 3, wherein a proximal end of the resilient member is fixed to the axle, and a distal end of the resilient member is free from the axle, so that a displacement of the resilient member increases in the direction of the free end when the substrate roll is moved with respect to the axle.

5. Print substrate roll axle according to claim 1, wherein the transmission member comprises a gear.

6. Print substrate roll axle according to claim 1, wherein
the print substrate roll axle comprises a support portion for supporting the substrate roll, and
the resilient member extends along the support portion.

7. Print substrate roll axle according to claim 1, wherein the resilient member is fixed to the axle and partly arranged to move with respect to the axle.

8. Print substrate roll axle according to claim 7, comprising an abutment edge for preventing further movement of the respective part of the resilient member with respect to the axle.

9. Print system, comprising
a substrate roll,
a drive mechanism coupled the substrate roll for controlling a rotation of the substrate roll, and
a resilient member arranged between the substrate roll and the drive mechanism, arranged to at least partly move in a rotational direction of the substrate roll.

10. Print system according to claim 9, comprising at least one axle connected to the substrate roll, being provided with said resilient member.

11. Print system according to claim 10, wherein
the axle extends within a hollow core of the substrate roll,
the resilient member engages the substrate roll so as to clamp the axle within the substrate roll, and
the resilient member is arranged to at least partly move along the circumference of the axle to allow rotation of the substrate roll with respect to the axle.

12. Print system according to claim 11, wherein the resilient member is arranged to allow rotation of the axle with respect to the substrate roll by stretching the resilient member.

13. Print system according to claim 10, comprising one axle at each end of the substrate roll.

14. Print system according to claim 13, wherein
one of the axles comprises a transmission member engaging the drive mechanism.

15. Print system according to claim 9, wherein the resilient member has an elongated shape and at least partly extends approximately parallel to the longitudinal axis of the substrate roll.

16. Print system according to claim 9, comprising a large format printer.

17. Method of maintaining a tension in a substrate for printing, comprising
connecting a substrate roll to a print system, the print system engaging the substrate roll via a resilient member,
moving an unwound part of the substrate roll between the substrate roll and a print head of the print system, and
stretching the resilient member in a rotational direction of the substrate roll so that a torque is provided to the substrate roll by the resilient member.

18. Method according to claim 17, comprising
connecting an axle to each longitudinal end of the substrate roll, and
coupling the axles with the print system.

19. Method according to claim 17, comprising
at least one axle comprising the resilient member,
inserting an axle into the substrate roll so that the resilient member engages the substrate roll,
rotating the axle with respect to the substrate roll
stretching the resilient member at least partly in a circumferential direction of the axle, and
tensioning an unwound part of the substrate.

20. Method according to claim 19, wherein the resilient member partly moves with respect to the axle while stretching,
the moving part engages an abutment edge of the axle that prevents further moving of the resilient member with respect to the axle, and
the axle and resilient member rotate together.
